(19) United States
(12) Patent Application Publication
(10) Pub. No.: US 2010/0064078 A1
(43) Pub. Date: Mar. 11, 2010

(54) WIRELESS COMMUNICATION BETWEEN TESTING INSTRUMENT AND NETWORK

(76) Inventor: Thomas J. Powell, Marion, IN (US)

Correspondence Address: BARNES & THORNBURG LLP, 11 SOUTH MERIDIAN, INDIANAPOLIS, IN, 46204, US

(21) Appl. No.: 12/538,391

(22) Filed: Aug. 10, 2009

Related U.S. Application Data
(60) Provisional application No. 61/089,091, filed on Aug. 15, 2008.
(60) Provisional application No. 61/100,794, filed on Sep. 29, 2008.

(51) Int. Cl. G06F 13/12

(52) U.S. Cl. 710/69

(57) ABSTRACT

An instrument for testing a CATV network includes a microcomputer for controlling the instrument, a memory coupled to the microcomputer, a keypad user interface coupled to the microcomputer, a digital signal processor (DSP) coupled to the microcomputer to be controlled thereby, an RF section, an analog-to-digital (A/D) converter coupled to the RF section and to the DSP, and a wireless adapter coupled to the microcomputer to provide wireless communication between the instrument and an internetwork access point.

### CROSS REFERENCE TO RELATED APPLICATIONS

This application claims the benefit of the Aug. 15, 2008 filing date of U.S. Ser. No. 61/089,091 and the benefit of the Sep. 29, 2008 filing date of U.S. Ser. No. 61/100,794. The disclosures of U.S. Ser. No. 61/089,091 and U.S. Ser. No. 61/100,794 are hereby incorporated herein by reference.

### FIELD OF THE DISCLOSURE

This disclosure relates to data transport. It is disclosed in the context of a network testing instrument, but is believed to be useful in other applications as well.

### BACKGROUND

Various types of network testing instruments are known. There are, for example, the instruments described in published U.S. patent application 2002-0019983-A1; U.S. Pat. Nos. 6,310,646; 6,802,032; 6,425,132; 6,234,389; and, 6,891,803; and the prior art cited in these, including U.S. Pat. Nos. 4,599,644; 5,294,981; 5,465,112; 5,477,150; 5,495,282; 5,633,582; 5,777,662; 5,864,754; 5,889,759; 5,914,608; 5,357,519; 5,619,489; 5,884,202; 6,516,427; 6,535,838; 6,588,016; 6,917,595; 3,750,022; 3,924,187; 4,029,913; 4,365,249; 4,520,508; 4,810,898; 5,260,648; 5,585,842; 5,631,846; 5,867,206; 5,881,363; 6,002,671; 6,044,090; 3,863,050; 4,034,211; 4,758,714; 4,775,784; 5,438,186; 5,440,108; 5,625,534; 3,956,601; 4,402,055; 4,536,703; 4,651,298; 4,837,811; 4,843,620; 4,887,260; 4,894,829; 4,922,516; 4,996,695; 5,121,342; 5,173,896; 5,227,988; 5,251,150; 5,331,136; 5,363,366; 5,377,128; 5,377,196; 5,377,259; 5,381,348; 5,382,910; 5,432,705; 5,511,108; 5,521,958; 5,528,660; 5,530,367; 5,533,093; 5,557,539; 5,566,088; 5,567,925; 5,583,912; 5,602,750; 5,608,644; 5,644,573; 5,715,437; 5,757,680; 5,790,432; 5,805,517; 5,812,786; 5,847,749; 5,850,209; 5,864,662; 5,892,458; 5,916,287; 5,920,608; 5,946,641; 5,956,385; 5,982,851; 6,038,520; 6,064,721; 6,385,300; 6,590,963; 6,738,454; published German patent applications: DE 31 16 079; DE 37 43 446; DE 39 12 230; DE 39 33 222; DE 40 25 417; DE 195 09 690; and, DE 199 54 348; European Patents: EP 053 561; EP 532 346; French patent specification 2,694,813; Soviet Union patent specification 798,614; and, the following additional non-patent literature: Disclosure Statement on behalf of Assignee Sunrise Telecom, Inc., with attached Declaration of Robert King, Vice President—North American Sales, Sunrise Telecom, Inc.; Declaration of Paul Marshall, Chief Operating Officer, Vice President of Marketing and Acting Chief Financial Officer of Sunrise Telecom Incorporated, San Jose, Calif., dated Mar. 3, 2004, pp. 1-3, with Exhibits A, B and C; Specialized Products Company, 1994 Spring Catalog, pp. 152, 168-169; Itronix Brochure, “T5000 EFP handheld Mobile Workstation,” undated; “Testing ATM Interoperability—HP Solution Note”, 5965-9334E June 1997 Rev. A, 1997 ATM/Broadband Testing Seminar, Hewlett-Packard Company; “Traveling Wave Fault Location in Power Transmission Systems”, Application Note 1285, Hewlett-Packard Company, February 1977, 5965-5296E; “Accurate Transmission Line Fault Location Using Synchronized Sampling”, Application Note 1276-1, Hewlett-Packard Company, 1996, 5964-6640E; and, “Time Domain Reflectometry Theory”, Application Note 1304-2, Hewlett-Packard Company, 1998, 5966-4855E. The disclosures of these references are hereby incorporated herein by reference. This listing is not intended to be a representation that a complete search of all relevant art has been made, or that no more pertinent art than that listed exists, or that the listed art is material to patentability. Nor should any such representation be inferred.

The complete disclosure of published U. S. patent application 2002-0019983-A1 is hereby incorporated herein by reference.

### SUMMARY

An instrument for testing a CATV network includes a microcomputer (μC) for controlling the instrument, a memory coupled to the μC, a keypad user interface coupled to the μC, a digital signal processor (DSP) coupled to the μC to be controlled thereby, an RF section, an analog-to-digital (A/D) converter coupled to the RF section and to the DSP, and a wireless adapter coupled to the μC to provide wireless communication between the instrument and an internetwork access point.

Illustratively, the wireless adapter comprises one of: a WiFi adapter; a mobile broadband adapter; a WiMAX adapter; a Bluetooth adapter; a ZigBee® adapter; a Lightweight Telephony Protocol (LTP) adapter; a Long Term Evolution (LTE) adapter; and, a custom RF interface adapter.

If the wireless adapter comprises a WiFi adapter, the instrument illustratively further comprises an ethernet interface coupled to the μC and a routing switch coupled to the ethernet interface.

If the wireless adapter comprises a mobile broadband adapter, the instrument illustratively further comprises a universal serial bus (USB) port coupled to the μC. The mobile broadband adapter illustratively is coupled to the USB port.

Alternatively, if the wireless adapter comprises a mobile broadband adapter, the instrument illustratively further comprises a port coupled to the μC to receive the mobile broadband adapter.

If the wireless adapter comprises a WiMAX adapter, the instrument illustratively further comprises an ethernet interface coupled to the μC. The WiMAX adapter illustratively is coupled to the ethernet interface.

### BRIEF DESCRIPTION OF THE DRAWING

The disclosure may best be understood by referring to the following detailed description and accompanying drawing which illustrates the disclosure. The drawing illustrates a block diagram of certain embodiments constructed according to the disclosure.

### DETAILED DESCRIPTIONS OF ILLUSTRATIVE EMBODIMENTS

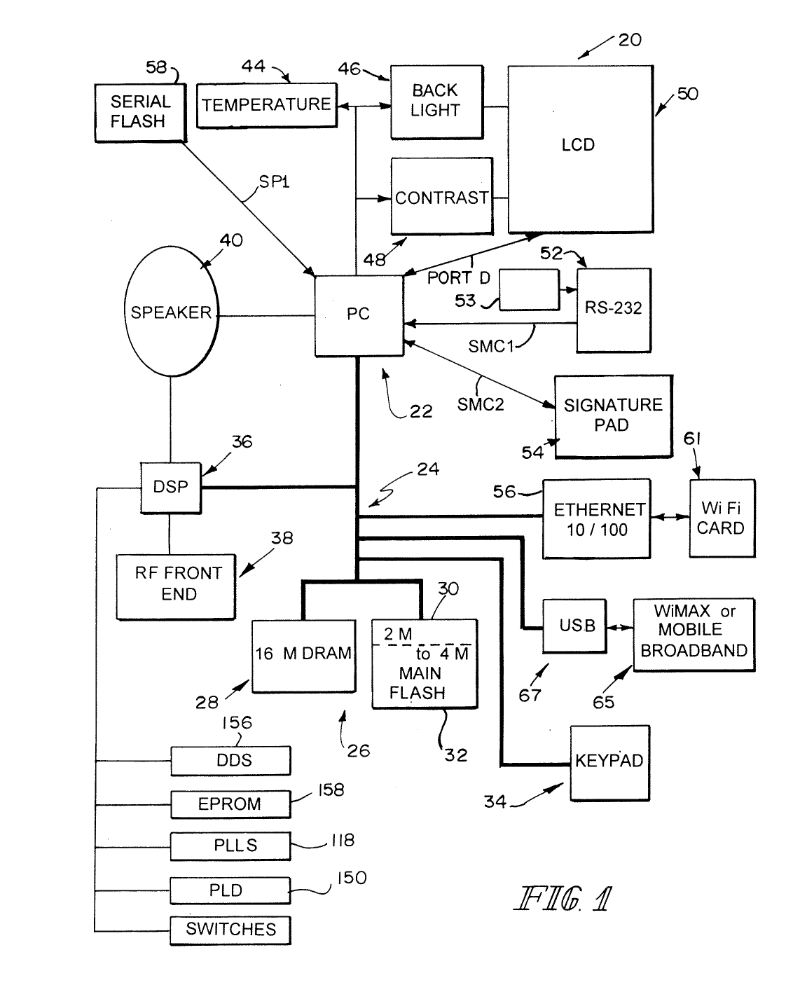

Turning now to FIG. 1, an instrument 20 constructed according to the invention is controlled by a computer 22 such as, for example, a Motorola XPC823ZT66 Power PC. Computer 22 will sometimes be referred to hereinafter as μC 22. A thirty-two bit bus 24 couples μC 22 to a memory 26 including, for example, a 16 Mbyte dynamic random access memory (DRAM) 28, a 2 Mbyte main up to a 4 Mbyte main flash memory 30. DRAM 28 may be, for example, a Micron type MT48LC8M8A2TG-8E DRAM. Main flash memory 30 may be, for example, a Sharp type LH28F160BVHE-BTL90 memory. A telephone-type keypad user interface 34 resides on bus 24. A digital signal processor (DSP) 36, such as, for example, an Analog Devices type ADSP-2189 DSP, is also coupled to the bus 24. DSP 36, under the control of μC 22, provides the instrument 20's interface to the instrument 20's RF section 38 and analog-to-digital converter (A/D) that converts signals from the RF section 38 for processing by the digital section of instrument 20. A/D may be, for example, an Analog Devices AD9203. An audio transducer 40 receives input both from the μC 22, for simple tones, and from the DSP 36, for more complex audio control.

An I²C port of μC 22 is coupled to a temperature sensor 44 such as, for example, a Dallas Semiconductor type DS75S temperature sensor, to an LCD backlight controller 46, such as, for example, a Maxim type MAX1611 IC, and to an LCD contrast controller 48, such as, for example, a Maxim type MAX1621 IC. The backlight and contrast controllers 46, 48, and port D of the μC 22 are all coupled to a display 50, such as, for example, a Hantronix, Inc., type HDM3224-1-M20F, one-quarter VGA LCD subsystem running 2-bit per pixel gray scale, or a color LCD display. The SMC1 port of μC 22 is coupled to an RS-232 port 52, such as, for example, a Maxim type MAX3226ECAE IC RS-232 interface IC. A bar code scanner 53 can be coupled to the RS-232 port 52 to permit scanning of the bar codes with which CATV system equipment, including subscriber terminal equipment, is often provided. The SMC2 port of μC 22 is coupled to a signature pad 54, such as, for example, a 9600 baud serial Interlink Electronics Versapad VP8000 touchpad. The SCC1 port of μC 22 is coupled to an Ethernet (IEEE 802.3) interface 56, such as, for example, a 10 Mbit Level One type LXT901ALC IC ethernet interface IC. The SPI port of μC 22 is coupled to a memory 58, such as, for example, an Atmel type AT45DB161-TC 256K to 4 M serial flash memory, for storing customer files, DSP algorithms, calibration tables, channel plans, and the like.

A direct digital synthesizer (DDS) 156, such as, for example, an Analog Devices type AS9851 DDS, an erasable programmable read-only memory 158, such as, for example, an Atmel type AT25640 serial EPROM, a Phase Locked Loop (PLL) circuit 118, such as a National Semiconductor LMX2352 PLL IC, and a Programmable Logic Device, or PLD, 150, such as, for example, a Xilinx model XC9572XL PLD for controlling RF section 38, may be coupled to DSP 36 as described, and for the purpose(s) described, in published U. S. patent application 2002-0019983-A1.

In an instrument 20 of the general type illustrated and described in published U. S. patent application 2002-0019983-A1, it is desirable to be able to communicate wirelessly with a network such as, for example, the Internet, through any wireless Internet access point in order to communicate with a CATV (cable) system's upstream data management server, for example, a Trilithic Data Manager server, without using the instrument's built-in cable modem. (Trilithic Data Manager is data management software available from Trilithic, Inc., 9710 Park Davis Drive, Indianapolis, Ind., 46235. The Trilithic Data Manager data management software resides on a Windows® 2003-capable server.) This provides flexibility to the operator of the instrument through greater mobility, enhanced workgroup collaboration between the operator and other cable system employees, increased productivity, time savings, ease of use, and better care of cable system subscribers and subscribers' facilities and equipment. It also provides another way for the instrument to communicate with the upstream data management server without having to have a provisioned account with the cable system operator, which may incur additional cost.

In an illustrated example, an instrument of the type described is provided with a wireless, for example, WiFi (IEEE 802.11), card 61. This enables the instrument to communicate with wireless networks, with cable system work areas and with, for example, a Trilithic Data Manager server, verify and test connectivity to wireless networks, verify and test signal strength to wireless networks, verify and test wireless network bandwidth, facilitate workforce management, facilitate dynamic dispatch, and enable contouring of the wireless network's range or field. Without the present invention, test instruments would have to connect to the upstream data management server via the cable system's cable modem termination system through RF.

To accommodate the additional hardware, an additional routing switch is provided on the 2002-0019983-A1 instrument's existing 10/100 Mbps ethernet interface 56, and the ethernet interface 56 provides this input directly to the 2002-0019983-A1 instrument's data/address bus 24. Some other wireless means 65 could be used to accommodate the additional hardware. Such means 65 include, for example, mobile broadband (as established by IEEE 802.20, the Mobile Broadband Wireless Access (MBWA) Working Group) cards and WiMAX (based on the IEEE 802.16 standard). Mobile broadband could use, for example, the 2002-0019983-A1 instrument's USB port 67. WiMAX could use the 2002-0019983-A1 instrument's existing ethernet interface 56. A user could also employ another wireless format, such as Bluetooth (http://en.wikipedia.org/wiki/Bluetooth), ZigBee® (http://en.wikipedia.org/wiki/ZigBee), Lightweight Telephony Protocol (LTP) (http://lightweighttelephony.org/rfc.html), Long Term Evolution (LTE) (http://en.wikipedia.org/wiki/3GPP_Long_Term_Evolution) or a custom RF interface to a point of presence device, for communicating with the 2002-0019983-A1 instrument. However, using any of such formats as Bluetooth, ZigBee®, LTP, LTE or a custom RF interface would require some additional effort.

What is claimed is:

1. An instrument for testing a CATV network, the instrument including a microcomputer (μC) for controlling the instrument, a memory coupled to the μC, a keypad user interface coupled to the μC, a digital signal processor (DSP) coupled to the μC to be controlled thereby, an RF section, an analog-to-digital converter coupled
to the RF section and to the DSP, and a wireless adapter coupled to the μC to provide wireless communication between the instrument and a network access point.

2. The instrument of claim 1 wherein the wireless adapter comprises a WiFi adapter.

3. The instrument of claim 2 further comprising an ethernet interface coupled to the μC and a routing switch coupled to the ethernet interface.

4. The instrument of claim 1 wherein the wireless adapter comprises a mobile broadband adapter.

5. The instrument of claim 4 further comprising a universal serial bus (USB) port coupled to the μC, the mobile broadband adapter coupled to the USB port.

6. The instrument of claim 1 wherein the wireless adapter comprises a WiMAX adapter.

7. The instrument of claim 6 further comprising an ethernet interface coupled to the μC and to the WiMAX adapter.

8. The instrument of claim 1 wherein the wireless adapter comprises a Bluetooth adapter.

9. The instrument of claim 1 wherein the wireless adapter comprises a ZigBee® adapter.

10. The instrument of claim 1 wherein the wireless adapter comprises a Lightweight Telephony Protocol (LTP) adapter.

11. The instrument of claim 1 wherein the wireless adapter comprises a Long Term Evolution (LTE) interface adapter.

12. The instrument of claim 1 wherein the wireless adapter comprises a custom RF interface adapter.
